(19) United States
(12) Patent Application Publication
(10) Pub. No.: US 2015/0202660 A1
(43) Pub. Date: Jul. 23, 2015

(54) Paint Cleaner

(71) Applicants: Anthony Ciaschi, Ithaca, NY (US); Kyle Stazi, Ithaca, NY (US)

(72) Inventors: Anthony Ciaschi, Ithaca, NY (US); Kyle Stazi, Ithaca, NY (US)

(21) Appl. No.: 14/600,165

(22) Filed: Jan. 20, 2015

Related U.S. Application Data
(60) Provisional application No. 61/930,149, filed on Jan. 22, 2014.

(51) Int. Cl. B08B 3/02

(52) U.S. Cl. CPC B08B 3/02

(57) ABSTRACT

A paint cleaner includes a housing, a drain, a cap, and a water conduit. The housing includes a housing wall having a first open end and a second open end opposite the first open end. The drain extends from the first open end of the housing and has a drain opening. The cap includes a cap body coupled to the second open end of the housing, a holder to receive a paint roller cover or a brush handle of a paint brush, and a spinner coupling the holder to the cap body such that the holder is rotatable with respect to the cap body to rotate the paint roller cover or the paint brush within the housing. The water conduit supplies water to an enclosure formed by the housing, cap, and drain and directs the water to the paint roller cover or the bristles of the paint brush.

### REFERENCE TO RELATED APPLICATIONS

This application claims one or more inventions which were disclosed in Provisional Application No. 61/930,149, filed Jan. 22, 2014, entitled “PAINT CLEANER”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of cleaning devices. More particularly, the invention pertains to cleaners for paint roller covers and paint brushes.

2. Description of Related Art

Water-based paints can be removed from paint roller covers or paint brushes by hand by holding the paint roller cover or paint brush under a running faucet in a sink or bathtub and manually rubbing the roller cover or brush until no more paint is visible in the runoff water. This method, however, is time-consuming and messy and wastes water.

Devices to aid in the removal of water-based paint from a brush or roller are known in the art.

U.S. Pat. No. 5,402,808, entitled “Paint Roller Cleaner” and issued Apr. 4, 1995 to Wallis et al., discloses a tubular housing, open at both ends, to receive the roller on its handle. A frame guide couples the handle to the housing. A water line attached to a water source applies water at a high pressure through apertures at an angle to the roller, causing the roller to spin on its handle and cleaning the paint from the handle. The tubular housing may be transparent or opaque. Three legs help the device to stand. The roller may be cleaned with only 20 to 25 seconds of water application to the roller.

U.S. Patent Application Publication No. 2011/0225836, entitled “Paint Applicator Cleaning Device” by Taylor and published Sep. 22, 2011, discloses a device to clean both paint roller covers and paint brushes. A paint roller cover is slid over a cylindrical collar of the device. A paint brush handle is inserted and held in a socket coaxial with a drive shaft of the device. The coaxial socket is adapted to accommodate many different brush sizes and shapes. An electric drill spins the drive shaft at a high speed (2,500 RPM) to remove the paint from the roller or brush without the use of water. The device provides no housing for the spinning brush or roller.

European Patent Application Publication No. 1 837 203, entitled “Brush and Roller Cleaner” by Watters et al. and published Sep. 26, 2007, includes a housing, can accommodate either a brush or a roller, has holes to spray water, and has a rotator knob to manually rotate a paint brush during cleaning. The roller handle may be attached to a roller frame clip so that the roller is placed in the cleaner housing without being taken off the roller handle. A paint brush is attached to a tool holder assembly and placed in the housing. A rotator knob allows manual rotation of the paint brush. Water comes out of holes or fan jets to spray the water toward the brush or roller. The lid may attach in one of two different ways, one of which puts the paint brush closer to the water spray than the other. A control knob allows manual side-to-side pivoting of the spray line to change the direction of the water.

The above-mentioned patent publications are hereby incorporated by reference herein.

### SUMMARY OF THE INVENTION

A paint cleaner includes a housing, a drain, a cap, and a water conduit. The housing includes a housing wall having a first open end and a second open end opposite the first open end. The drain extends from the first open end of the housing and has a drain opening. The cap includes a cap body coupled to the second open end of the housing, a holder to receive a paint roller cover or a brush handle of a paint brush, and a spinner coupling the holder to the cap body such that the holder is rotatable with respect to the cap body to rotate the paint roller cover or the paint brush within the housing. The water conduit supplies water to an enclosure formed by the housing, cap, and drain and directs the water to the paint roller cover or the bristles of the paint brush.

### BRIEF DESCRIPTION OF THE DRAWINGS

FIG. 1 shows a schematic partial cross sectional side view of a paint cleaner in an embodiment of the present invention.

FIG. 2 shows a schematic partial cross sectional side view of the paint cleaner of FIG. 1 holding a paint roller cover.

FIG. 3 shows a spinner and a holder with a plug design for holding a paint roller cover but no clip for holding a paint brush.

FIG. 4A shows a schematic partial cross sectional side view of a spinner actuated by an electric drill.

FIG. 4B shows a schematic partial cross sectional side view of the spinner of FIG. 4A actuated by a hand crank.

FIG. 4C shows schematically a top view of the spinner of FIG. 4A.

FIG. 5 shows a schematic partial cross sectional side view of a water conduit with a three-way valve, tubing for cleaning a paint roller cover, and tubing for cleaning a paint brush.

FIG. 6 shows a schematic partial cross sectional side view of a water conduit with a lip extending around the inner side of the housing wall to drench the paint roller cover with water from above.

FIG. 7 shows a schematic partial cross sectional side view of a water conduit extending vertically through the housing wall to slits in the housing wall.

FIG. 8 shows a schematic partial cross sectional top view of a water conduit with slits directing water at an off-axis angle to spin the paint roller cover.

FIG. 9 shows a schematic partial cross sectional side view of a water conduit with tubing spiraling downward along the inner side of the housing wall.

FIG. 10 shows a schematic perspective view of a paint cleaner in an embodiment of the present invention.

FIG. 11 shows an exploded view of portions of the paint cleaner of FIG. 10.

FIG. 12 shows a top view of the upper drain of the paint cleaner of FIG. 10.

FIG. 13 shows a cross sectional side view of the drain of FIG. 12 along line 13-13.

FIG. 14 shows a perspective view of the spinner and holder of the paint cleaner of FIG. 10.

FIG. 15 shows a side view of the lid of the cap of the paint cleaner of FIG. 10.

FIG. 16 shows a cross sectional view of the lid of FIG. 15.

FIG. 17 shows a top view of the top water inlet of the cap of the paint cleaner of FIG. 10.

FIG. 18 shows a cross sectional side view of the top water inlet of FIG. 17 along line 18-18.

FIG. 19 shows a partial cross sectional side view of the top water inlet of FIG. 17 along line 19-19.

FIG. 20 shows a partial cross sectional side view of the top water inlet of FIG. 17 along line 20-20.

FIG. 21A shows a side view of the u-shaped nozzle of the paint cleaner of FIG. 10.

FIG. 21B shows a top view of the u-shaped nozzle of FIG. 21A.

FIG. 21C shows a view of the inward-facing side of one of the vertical portions of the u-shaped nozzle of FIG. 21A.

FIG. 22 shows the inward-facing side of one of the straight nozzles of the paint cleaner of FIG. 10.

FIG. 23 shows a cross sectional schematic view of a paint cleaner for simultaneously cleaning more than one painting implement in an embodiment of the present invention.

FIG. 24 shows a cross sectional schematic view of a paint cleaner with a nozzle ring in an embodiment of the present invention.

FIG. 25 shows a cross sectional schematic view of a paint cleaner with an electric motor in an embodiment of the present invention.

FIG. 26 shows a front view of the moving nozzle of the paint cleaner of FIG. 25.

FIG. 27 shows a schematic top view of a water-actuated spinner in an embodiment of the present invention.

### DETAILED DESCRIPTION OF THE INVENTION

A paint cleaner includes a housing, a cap, a water conduit, and a drain and aids in the removal of paint from a paint roller cover or a paint brush. The cap includes a cap body, a holder, and a spinner. The housing is preferably cylindrical or substantially cylindrical in shape. The cap body is preferably removable from the first end of the housing. The holder holds the paint roller cover or the paint brush in the enclosure formed by the cap body, the housing, and the drain. The spinner allows the holder and paint roller cover or paint brush to rotate with respect to the cap body. The water conduit directs water to contact the outer surface of the paint roller cover or the brush of the paint brush. The drain directs water and paint runoff.

In some embodiments, the paint cleaner is a paint roller cover cleaner. In such embodiments, the holder is preferably designed to hold a paint roller cover but not a paint brush. In such embodiments, the housing, the water conduit, and cap body are preferably designed for cleaning a paint roller cover but not a paint brush.

In other embodiments, the paint cleaner is a paint brush cleaner. In such embodiments, the holder is preferably designed to hold a paint brush but not a paint roller cover. In such embodiments, the housing, the water conduit, and cap body are preferably designed for cleaning a paint brush but not a paint roller cover.

In other embodiments, the paint cleaner is a paint roller cover cleaner and a paint brush cleaner. In such embodiments, the holder is preferably designed to accommodate separately, but not simultaneously, either a paint brush or a paint roller cover. In such embodiments, the housing, the water conduit, and cap body are preferably designed for cleaning separately, but not simultaneously, a paint brush and a paint roller cover. In yet other embodiments, the housing is sized and shaped to simultaneously receive more than one paint brush, more than one paint roller cover, or at least one paint brush and at least one paint roller cover.

A paint brush, as used herein, refers to any painting implement having a handle for manually holding the paint brush and bristles extending from the top of the handle, where the bristles are designed to hold wet paint and apply the wet paint to a surface, such as, for example, a wall, upon contact with the surface.

A paint roller cover, as used herein, has a cylindrical core with a pile fabric or foam rubber covering secured to the cylindrical core. The paint roller cover slides over a paint roller frame to form a paint roller. The paint roller cover on the paint roller frame is rotatable with respect to a handle extending from the paint roller frame. The paint roller cover is designed to hold wet paint and apply the wet paint to a large flat surface, such as, for example, a wall, upon contact with the flat surface. Conventional paint roller covers typically have an outer diameter of about three inches and are typically either 9 or 18 inches in length. Conventional junior paint roller covers typically have an outer diameter of about one inch and are typically three to six inches in length.

### Housing

The housing is preferably a lightweight cylindrical tube. In some embodiments, the housing is transparent so that the level of cleanness of the paint roller cover or paint brush can be visually assessed by looking into the housing enclosure during the cleaning process. The length of the housing is preferably in the range of 12 inches to 29 inches. In some embodiments, the housing is sized to receive a nine-inch paint roller cover, with the length of the housing being in the range of 12 to 18 inches. In other embodiments, the housing is sized to receive an 18-inch paint roller cover, with the length of the housing being in the range of 22 to 29 inches.

In some embodiments, the housing is made of a plastic material, which may be, but is not limited to, poly(vinyl chloride) (PVC) or poly(methyl methacrylate) (PMMA). In other embodiments, the housing is made of a metal material, which may be, but is not limited to, aluminum or steel.

In some embodiments, the housing has an inner diameter in the range of about 3 inches to about 4½ inches. In embodiments where the paint cleaner is only a paint roller cover cleaner, the inner diameter of the housing is preferably in the range of about 3 inches to about 4 inches. In embodiments where the paint cleaner is a paint roller cover cleaner and a paint brush cleaner, the inner diameter of the housing is preferably in the range of about 4 inches to about 4½ inches to accommodate a 4-inch brush. In other embodiments, the inner diameter of the housing may be larger than about 4½ inches to accommodate larger paint brushes.

The thickness of the housing wall is preferably in the range of about 0.15 inches to about half an inch. In embodiments where the water conduit is formed in part in the housing wall or passes vertically, in part, through the housing wall, the thickness of the housing wall is preferably at the upper end of the range, or about 0.25 inches to about 0.5 inches. In embodiments where the water conduit passes substantially only horizontally through the housing wall, the housing wall thickness is preferably at the lower end of the range, or about 0.15 inches to about 0.25 inches.

In some embodiments, the housing includes two concentric tubes, an inner tube and an outer tube. Both tubes may be transparent, translucent, or opaque. The outer tube, however, is optional and is primarily aesthetic. The water conduit from the intake valve to the cap is preferably located between the inner tube and the outer tube in such embodiments.

### Cap Body

In some embodiments, the cap body has a threaded outer edge and the top of the housing has a complementarily threaded edge to receive the threaded cap body. In other embodiments, an outer lip or multiple outer clips on the cap body are press-fit over the top edge of the housing to reversibly attach the cap to the housing.

In other embodiments, the cap body is permanently attached to the top of the housing, and a rubber gasket removably couples the spinner and holder to the cap body, such that the cap body need not be removed from the housing to put the paint roller cover or paint brush in the housing or take the paint roller cover or paint brush out of the housing. The diameter of the rubber gasket, however, may prevent larger paint brushes that might otherwise fit in the housing from being inserted and removed from the paint cleaner.

In some embodiments, the water conduit extends into and through part of the cap body to direct water into the enclosure formed by the cap body, the housing, and the drain.

### Holder

The holder for the paint roller cover is preferably sized such that the paint roller cover fits snugly over the holder. The holder may be designed with flexible ribs similar to a paint roller frame or have a semi-solid plug design, such as when the paint cleaner is only a paint roller cover cleaner.

In some embodiments, the holder is sized to receive a nine-inch paint roller cover. In other embodiments, the holder is sized to receive an 18-inch paint roller cover. In other embodiments, the holder is sized to receive a nine-inch paint roller cover or an 18-inch paint roller cover. In other embodiments, the paint cleaner includes two interchangeable holders that are reversibly attachable to the spinner: one holder sized to receive a nine-inch paint roller cover and the other holder sized to receive an 18-inch paint roller cover. In other embodiments, the same holder is used for a nine-inch paint roller cover or an 18-inch paint roller cover.

When the paint cleaner is a paint roller cover cleaner and a paint brush cleaner, the spinner preferably also includes a clamp to hold the handle of the paint brush in a vertical position with the bristles pointing downward.

In most embodiments, the holder is centered on the cap body such that a paint roller cover on the holder is substantially coaxial with the housing, thereby providing substantially equal distance between the paint roller cover and the inside of the housing wall. In some embodiments, such as when the water conduit includes a single tube down one side of the housing wall, the holder may be off-center to account for the space taken up by the single tube.

### Spinner

The spinner is coupled to the holder to spin with the holder and allows the holder, including the paint roller cover or the paint brush held by the holder, to rotate with respect to the cap body, and therefore also with respect to the housing. The spinner may be actuated manually, by an electric motor, or by attaching an external motor, such as from a screw gun. The spinner may be pulsed or continually actuated during application of water by the water conduit. Alternatively, the spinner may be actuated independently by the force of the water contacting the paint roller cover or paint brush or by the force of the water driving a gear, such as, for example, a paddle wheel on a vertical axis, in the cap coupled to the spinner shaft.

Although the spinner is preferably fixed to the cap body, as noted above in some embodiments, a rubber gasket removably couples the spinner and holder to the cap body, such that the cap body need not be removed from the housing to put the paint roller cover or paint brush in the housing or take the paint roller cover or paint brush out of the housing.

In some embodiments, the spinner is a hand pump-type spinner. The hand pump spinner is actuated by hand by pushing a knob or handle, extending upward from the top of the cap body, down toward the holder. This spinner type works well with most any water conduit designs. In some embodiments, the hand pump spinner is not only actuated during application of water by the water conduit but also to aid in removal of excess water from the paint roller cover or paint brush after the paint roller cover or paint brush has been cleaned and the water conduit has been turned off.

In other embodiments, the spinner is a crank spinner. The crank is preferably a hand crank and is preferably removably coupled to the cap.

In some embodiments, the spinner includes a fitting for a screw gun or other motor-driven tool with a rotating head. This allows the spinner to be actuated at any speed available from the tool.

In some embodiments, the spinner is designed such that the spinner includes a fitting to attach a crank and the spinner includes a fitting for a screw gun, an electric drill, or other motor-driven tool with a rotating head. This gives the user the option of a crank spinner or a motor-driven spinner. In some embodiments, the fitting for the screw gun or other motor-driven tool is the same fitting as used for the crank. In other embodiments, different fittings are used for the two different attachments.

In some embodiments, the spinner is designed to be actuatable by only the force of the water contacting a paint roller cover on the holder. In such embodiments, the spinner may also be independently actuatable by a hand pump, a hand crank, or a motor-driven tool as described above.

In some embodiments, the paint cleaner includes an electric motor mounted to the cap and driving the shaft of the spinner. The electric motor may be battery-powered but is preferably powered by electricity by way of an electrical cord that plugs into an electrical outlet. The electric motor preferably can be turned on and off manually and is preferably a variable speed electric motor with a control knob for the user to adjust the speed of the motor.

### Water Conduit

The water conduit preferably includes a hose fitting to reversibly couple the water conduit to a hose, which is coupled to a water source at its other end. In other embodiments, the hose is permanently attached at one end to become part of the water conduit. The water conduit preferably brings the water from the hose through a hole in the side of the housing or the cap and directs the water to the outer surface of the paint roller cover or the bristle part of the paint brush.

The water conduit preferably also includes an on/off valve to allow control of the water flow at the paint cleaner rather than at the faucet. In some embodiments, the water conduit includes one line for water to clean a paint roller cover and a second line for water to clean a paint brush, with a second valve or a three-way valve to direct water either to the first or second line.

The water conduit may have one of a number of different designs to apply water to the paint roller cover or paint brush.

In some embodiments, the water conduit releases a single large stream on top of the paint roller cover or paint brush to soak the paint roller cover or paint brush. In this embodiment, the water conduit may include a ring around the top of the unit, but not on the lid, that drenches the paint roller cover or paint brush from above. Alternatively, the water conduit may include a spout pouring water from the top, which is also not on the lid, but at the top of the housing.

In embodiments where the spinner is manually or electrically driven, the water conduit may direct the water primarily toward the axis of the spinner shaft, which is also the axis of the paint roller cover, in order to optimize penetration of the water into the paint roller cover to remove paint located deep in the paint roller cover.

In other embodiments, the water conduit includes a tube running vertically down the side of the housing with holes spraying streams in a controlled specific direction, which has the ability of spinning the paint roller cover or paint brush on its own without the use of another external spinning force. The tube is preferably a line/small hose with tiny holes or slits drilled all at the same angle.

The tubing is preferably less than about half an inch in diameter. In some embodiments, the tubing is about ¼inch in diameter. The holes or slits may be at an angle or straight into the tubing wall in order to direct the water passing through the holes or slits in a predetermined direction to provide an effective spray or stream for contacting and cleaning the paint roller cover or paint brush.

The water may exit the water conduit at any angle with respect to horizontal from about +80 degrees to about −80 degrees.

In yet other embodiments, the water conduit includes a spiral tube running around and down along the inner side of the housing wall with streams of water jetting out at a predetermined angle, which also has the ability of spinning the paint roller cover or paint brush on its own without the use of another external spinning force. The tube is preferably a line/small hose with tiny holes spiraling down inside of the tube with holes drilled at the same angle.

The tubing within the enclosure or within the housing wall preferably has an outside diameter of less than half an inch and preferably about 0.25 inches. In some embodiments, the tubing is made of a metal. In other embodiments, the tubing is made of a flexible plastic. In other embodiments, the tubing is made of a rigid or substantially rigid plastic.

In some embodiments, the water conduit includes at least two tubes running down along the inner side of the housing wall on opposite sides. In some such embodiments, the tubes are lines/small hoses with the same tiny holes or slits drilled at the same angle, where the slits permit a fan spray of water rather than a stream of water. In other such embodiments, the two different tubes have different water pressures, which is preferably achieved by the high pressure tube having smaller openings than the low pressure tube. The high pressure water streams are preferably directed to spin the paint roller cover in one direction, while the low pressure water streams are directed toward the axis of the roller cover or toward the direction opposite the direction of rotation to penetrate the roller cover surface and wash away paint more efficiently.

In embodiments where one or more tubes run down along the housing wall, the water conduit exit holes preferably provide streams of water to the entire length of the paint roller cover.

In other embodiments, one or more vertical holes in the housing wall serve as part of the water conduit. In some such embodiments, a tube is inserted into the vertical hole. In other embodiments, the vertical hole serves as part of the water conduit without any tubing extending into the vertical hole. Holes or slots through the inner side of the housing wall into the vertical hole direct the water from the vertical hole toward the paint roller cover or paint brush. Such embodiments have the advantage of being able to keep the entire inner diameter of the housing free for the paint roller cover or paint brush to spin within the housing.

In embodiments with an electrically-powered spinner, an electric motor may be used to drive a single powerful nozzle up and down a pair of shafts to spray water along the length of a paint roller cover rather than having tubing with holes along its length.

### Drain

A drain on the second end of the housing directs the runoff water and paint, with the aid of gravity, downward toward the sink basin, shower floor, or bathtub. The drain exit opening is smaller than the opening at the bottom of the housing. In some embodiments, the drain has a funnel shape such that the exiting water and paint are drained in a controlled manner, allowing the paint cleaner to be run in small bathrooms, with the exiting water and paint being directed into a bathtub or toilet.

The drain is preferably permanently attached to the bottom of the housing, but in some embodiments, the drain may be removable from the bottom of the housing to allow placement of the paint roller cover or paint brush on the holder and removal of the paint roller cover or paint brush from the holder through the bottom of the housing. In such embodiments, the cap may be non-removably attached to the top of the housing. In such embodiments, the drain may have a threaded outer edge with the bottom of the housing having a complementarily threaded edge to receive the threaded drain. In other embodiments, an outer lip or multiple outer clips on the drain are press-fit over the bottom edge of the housing to reversibly attach the drain to the housing.

In some embodiments, a small tube or pipe extends from the bottom of the drain to further help control and direct the exiting fluid and control splatter.

### Legs

The paint cleaner is preferably held in an upright position in a sink basin, shower, or bathtub with the cap on the housing being at the top end of the housing. In some embodiments, the paint cleaner further includes at least three legs, preferably attached to and extending from the housing, to allow the paint cleaner to be free-standing in the sink basin, shower, or bathtub or straddling the toilet. In some embodiments, the paint cleaner includes exactly three legs that act as a tripod to support the housing in an upright position. The legs are preferably foldable or retractable to provide a compact shape for transport when not in use.

In other embodiments, the paint cleaner includes a wide enough base at the bottom of the paint cleaner to be free-standing without any legs.

### Hose

In some embodiments, the hose permanently extends from the side of the housing as part of the water conduit. As noted above, in other embodiments, the water conduit preferably includes a hose fitting to reversibly couple the water conduit to a hose. In either embodiment, the other end of the hose preferably includes a fitting to couple the other end of the hose to a water source.

In other embodiments, a paint cleaner cleans more than one painting implement (paint brush or paint roller cover) simultaneously. In such embodiments, the housing is sized and shaped to hold more than one painting implement at a time. The housing may include a chamber for each painting implement with the chambers being separated by walls, or alternatively, partial walls or no walls between the chambers may be used. In such embodiments, the paint cleaner includes a separate holder for each paint implement to be cleaned. The paint cleaner may include a single cap and a single drain, or separate caps or separate drains for each of the holders and chambers. The tubes and nozzles for the water conduit are located to clean the multiple painting implements simultaneously. The spinners are preferably coupled, such as by an infinite belt or an infinite chain, to be spun simultaneously.

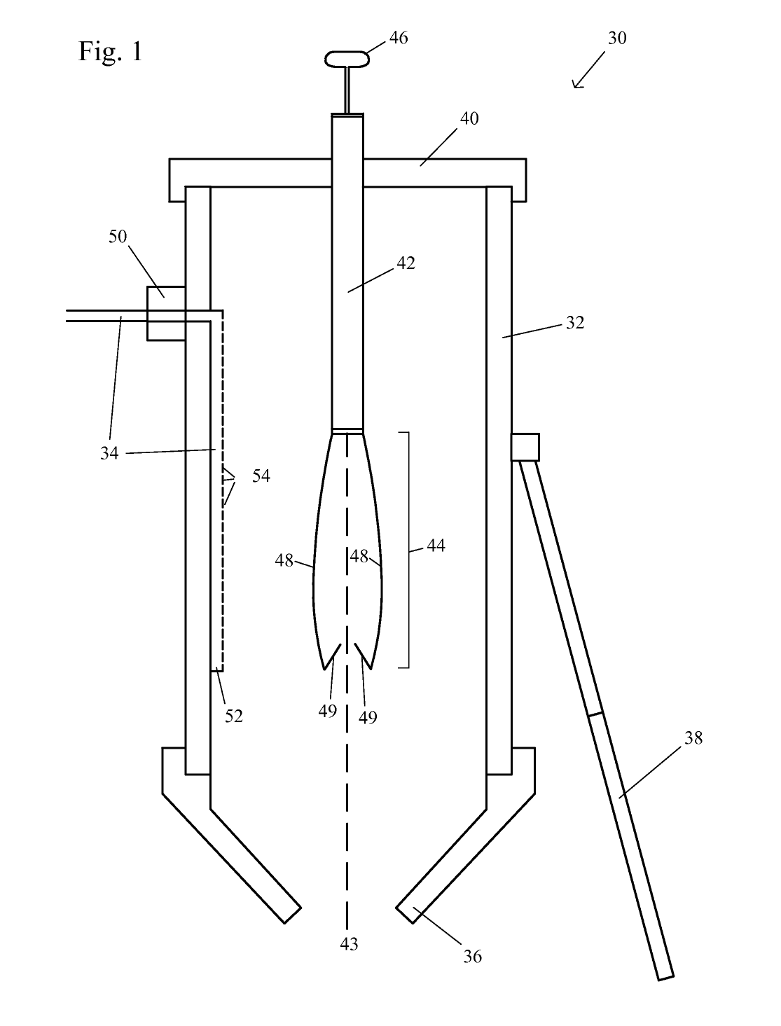

FIG. 1 shows a paint cleaner 30 with a housing 32, a cap, a water conduit 34, a drain 36, and legs 38. The cap includes a cap body 40, a spinner 42, and a holder 44. The spinner 42 includes a handle 46 that the user pushes in and pulls out to actuate the spinner 42 to spin on a central axis 43. The holder 44 includes ribs 48 for receiving a paint roller cover (not shown) and a clamp 49 for receiving a paint brush. A hose (not shown) attached to a water source supplies water to the water conduit. A valve 50 controls the flow of water through the water conduit 34. The water conduit 34 includes at least one tube 52 extending vertically down along the inside of the wall of the housing 32. The tube 52 includes holes or slits 54 to allow a spray of water to exit the water conduit 34 toward a paint roller cover or a paint brush being held by the holder 44 in the paint cleaner 30. Only one of the three legs 38 is visible in the view of FIG. 1. The legs 38 fold or retract for storage and transportation of the paint cleaner 30.

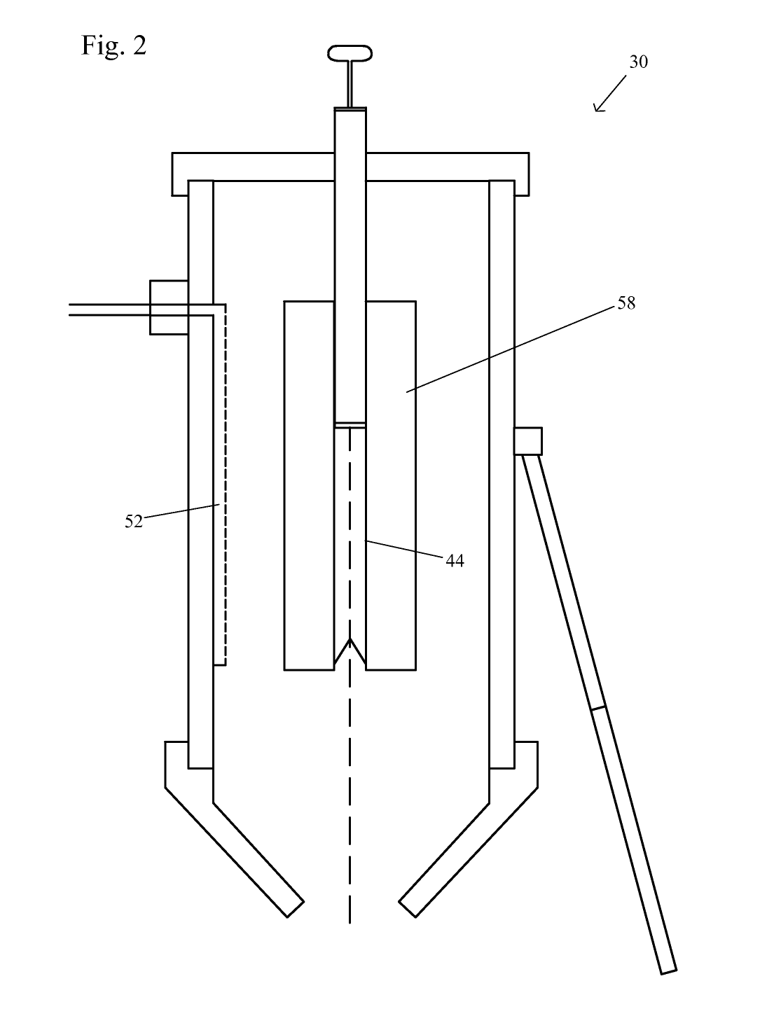

FIG. 2 shows a paint roller cover 58 being held on the holder 44 of the paint cleaner 30. The tubing 52 extends from the top of the paint roller cover 58 to the bottom of the paint roller cover 58.

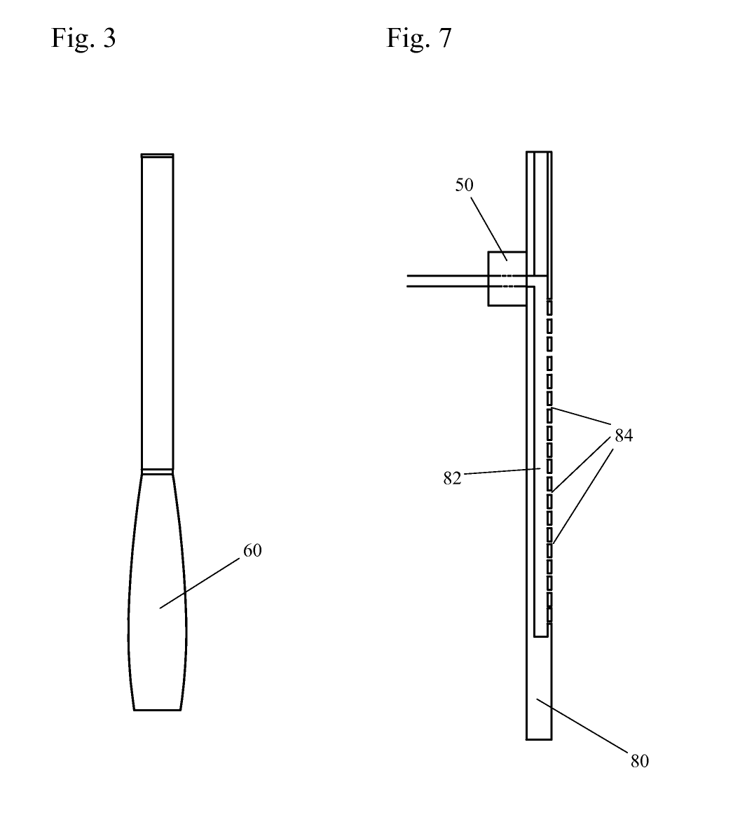

FIG. 3 shows an alternate design of a holder 60 with a solid plug design for holding a paint roller cover.

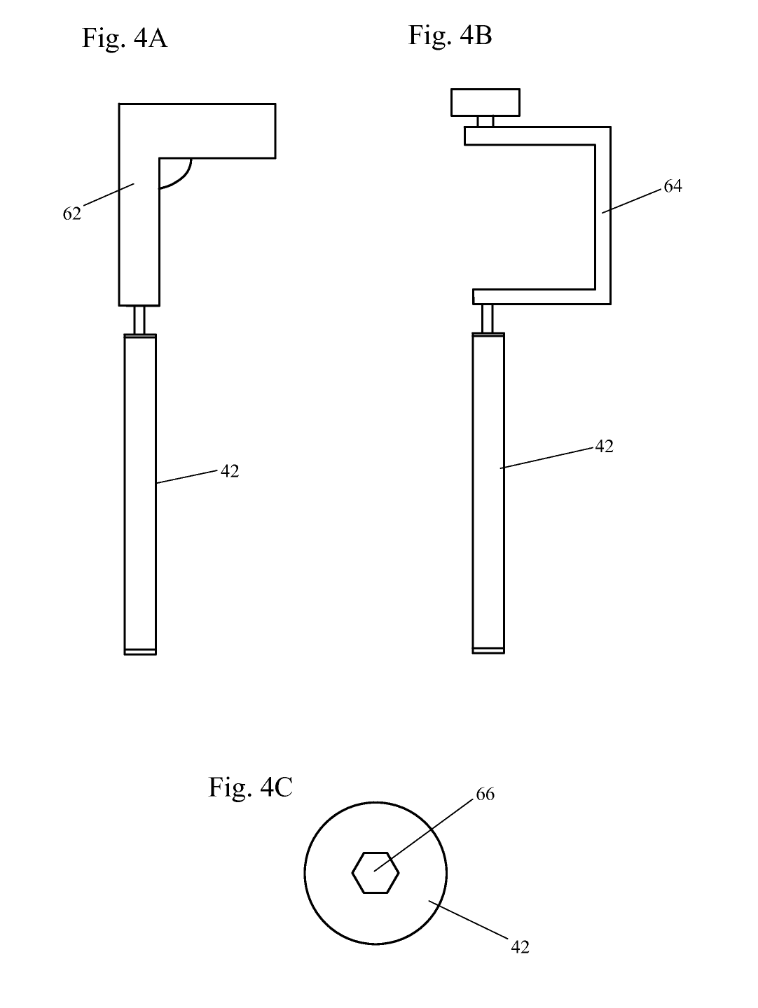

FIG. 4A shows an electric drill 62 coupled to the top of the spinner 42 to actuate the spinner 42. FIG. 4B shows a hand crank 64 coupled to the top of the spinner to actuate the spinner 42. FIG. 4C shows the hexagonal opening 66 on the top of the spinner 42 to couple the spinner 42 to the electric drill or the hand crank.

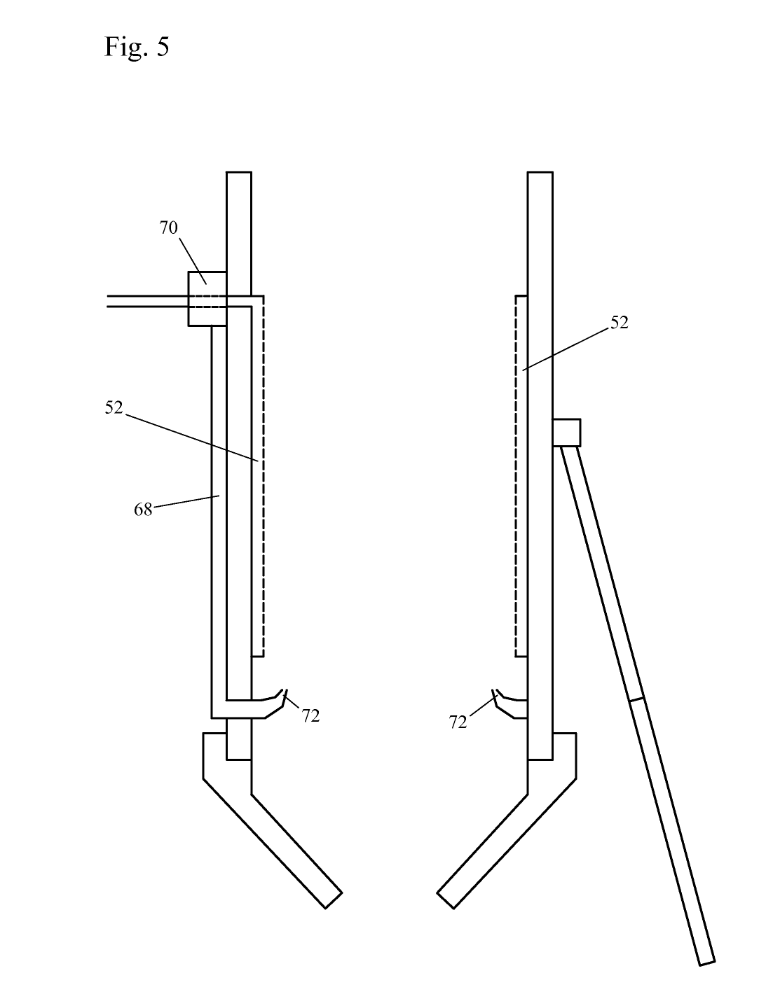

FIG. 5 shows a water conduit design with separate lines 52, 68 for cleaning a paint roller cover and a paint brush, respectively. The three-way valve 70 includes three positions—one in which no water passes through the valve, one in which water passes only to the paint roller cover line 52, and one in which water passes only to the paint brush line 68. Alternatively, the three-way valve 70 may be replaced with two two-way valves—one to turn the water off and on and the other to switch between the paint roller cover line 52 and the paint brush line 68. The paint brush line 68 includes at least one nozzle 72 angled upward toward the bristles of a paint brush being held by the holder to direct the water to wash the bristles from below.

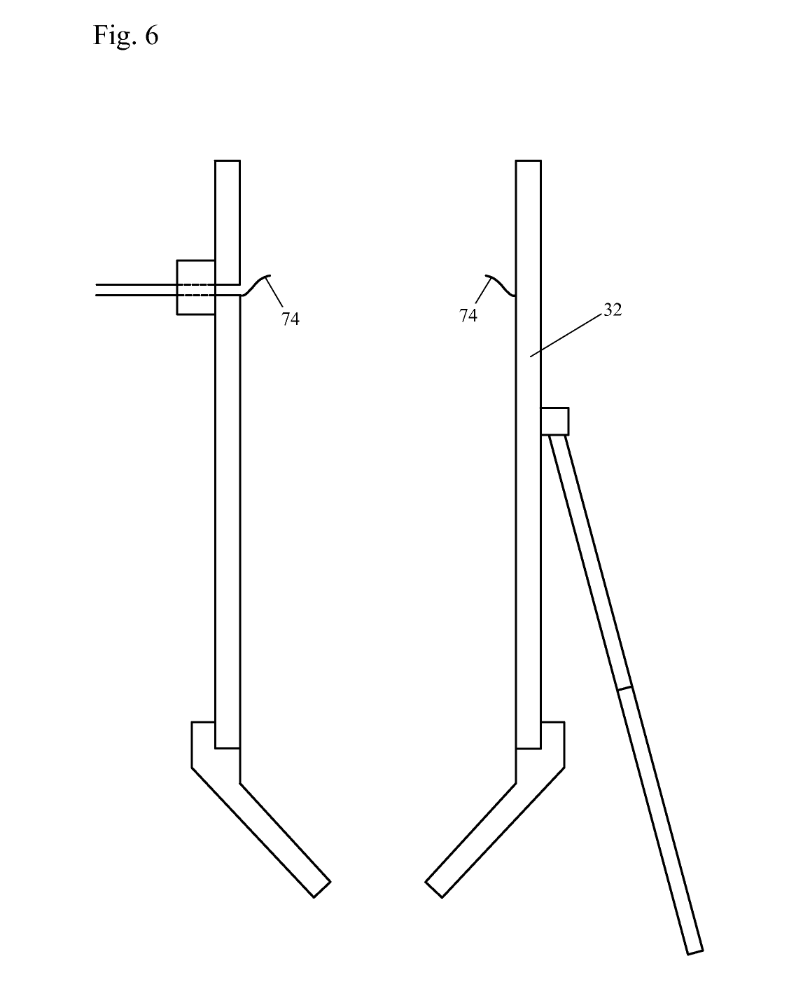

FIG. 6 shows a water conduit design with a lip 74 extending around the inner side of the wall of the housing 32 to drench the paint roller cover with water from above rather than tubing within the housing. The top of the lip 74 is preferably slightly higher near the valve than on the opposite side of the enclosure to provide a more even distribution of water flow over the lip 74.

FIG. 7 shows a water conduit design that does not physically extend into the enclosure at all. Instead, a hole has been drilled down from the top of the housing wall 80 to form a channel 82 to transport the water from the valve 50 to slits or holes 84 extending through the inner side of the housing wall 80.

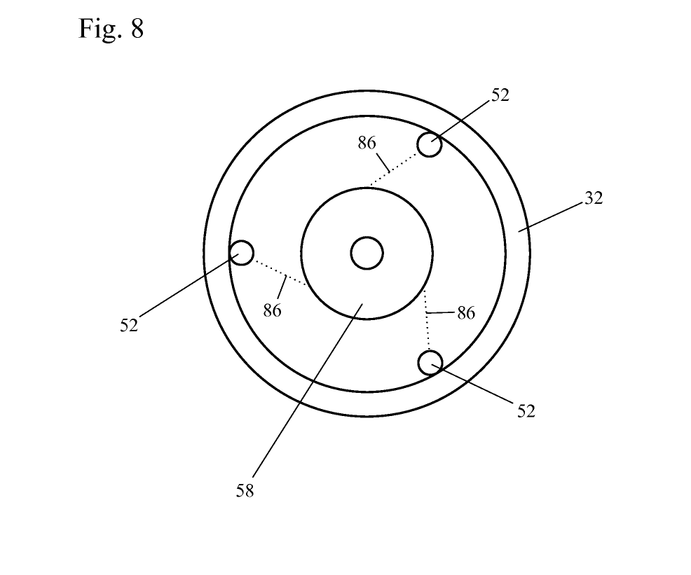

FIG. 8 shows a water conduit design with the slits or holes in the tubing 52 directing water 86 at an angle to contact the paint roller cover 58 off-axis rather than directly toward the central axis of the paint roller cover 58 in order to provide a force to spin the paint roller cover 58.

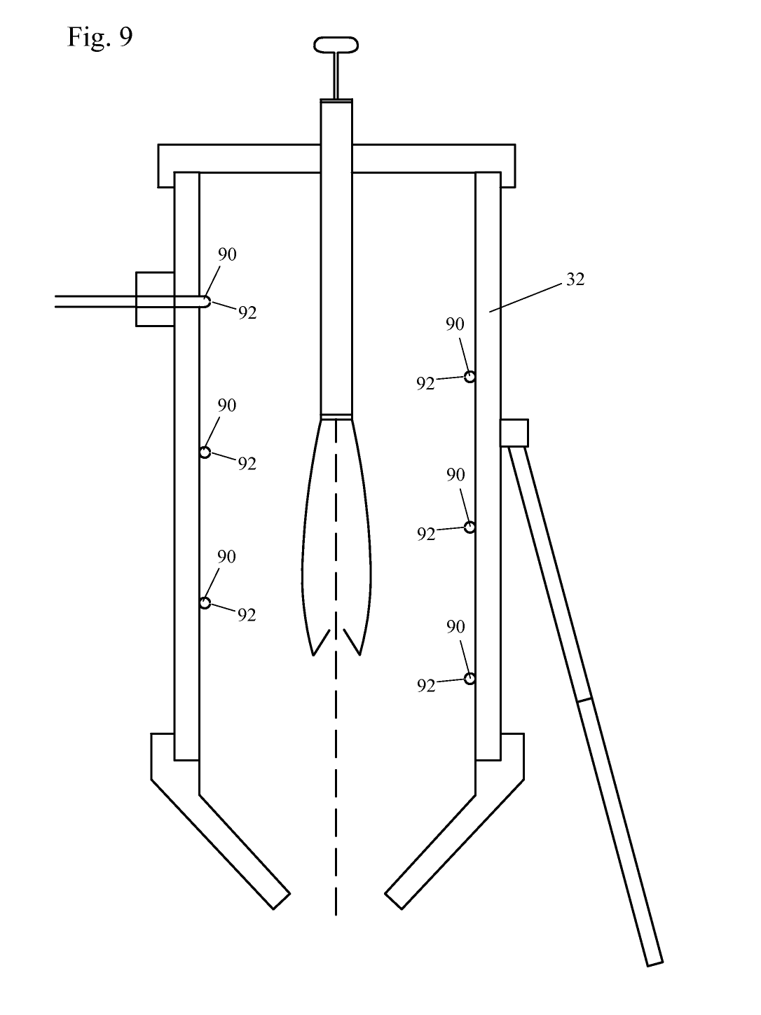

FIG. 9 shows a water conduit design with tubing 90 spiraling downward along the inner side of the wall of the housing 32. This water conduit design, as well as the designs of FIGS. 1, 5, and 7, may also include slits or holes 54, 84, 92 in the tubing 52, 90 or housing wall 80 that direct the water at an angle rather than directly toward the central axis of the paint roller cover in order to provide a force to spin the paint roller cover.

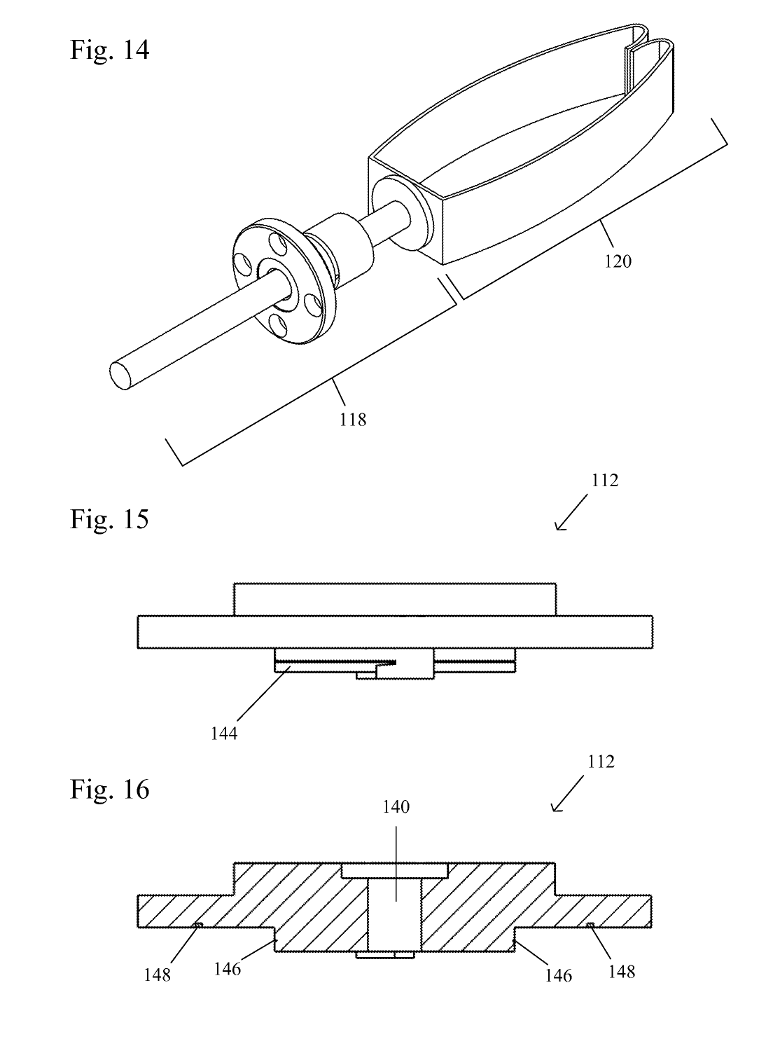

FIG. 10 through FIG. 22 show various views of portions of a paint cleaner 100 with a housing 102, a cap 104, a water conduit 106, and a drain 108. The cap body 110 of the cap 104 includes a lid 112 and a top water inlet 114. Two knobs 116 attach the lid 112 to the top water inlet 114. The cap 104 also includes the spinner 118 and the holder 120 shown in FIG. 14. A valve 122 controls entry of water into the conduit 106.

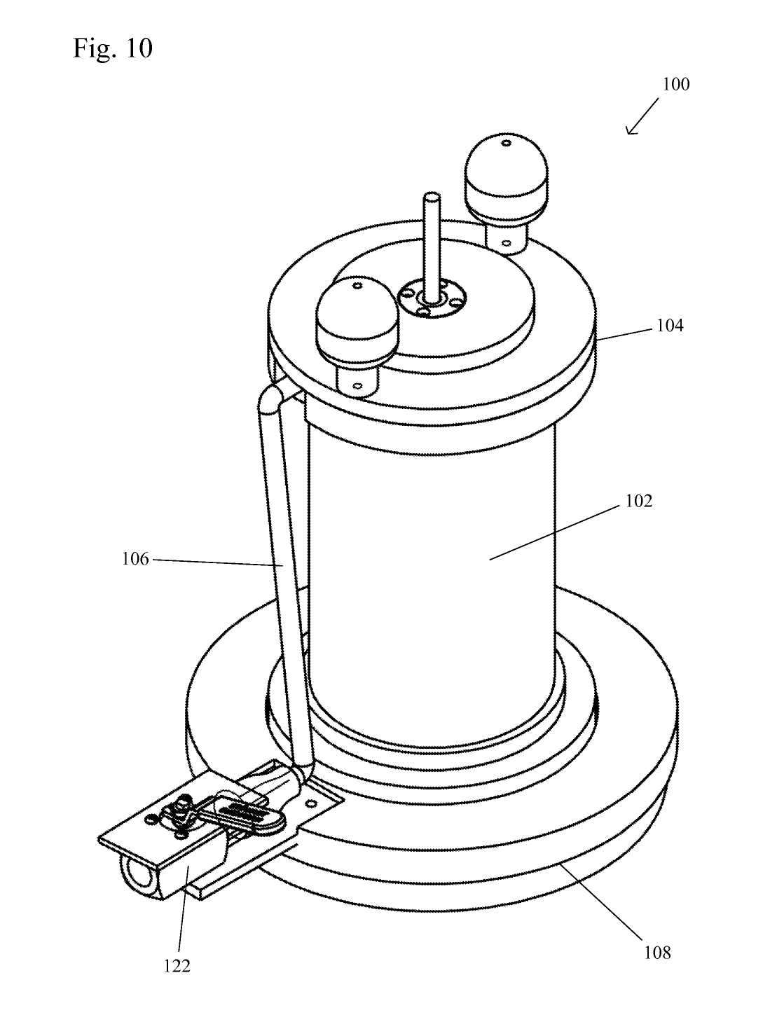

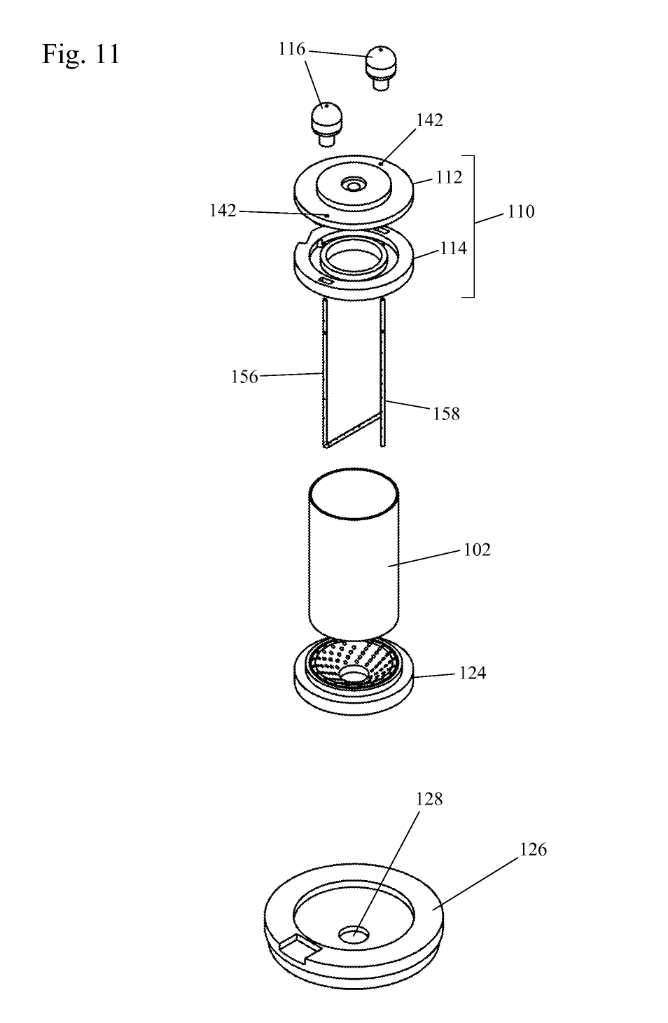

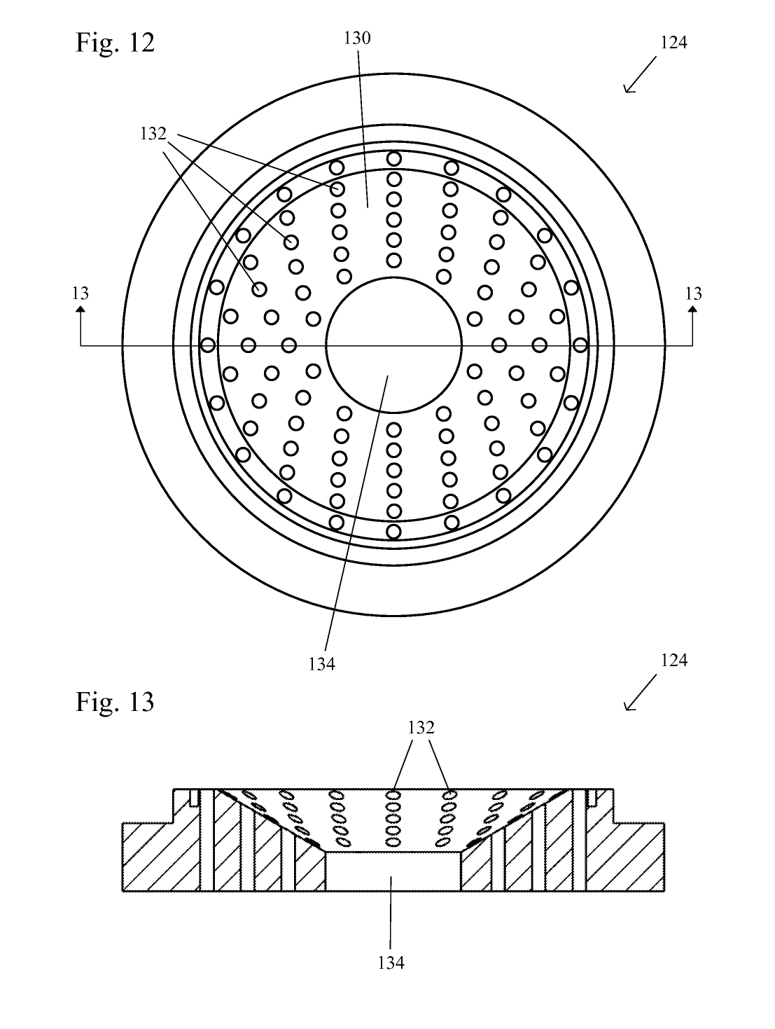

The drain 108 includes the filter 124 and the base 126 shown in FIG. 11. The filter 124 sits on the base 126. The base 126 includes a single central opening 128 by which the liquid runoff exits the paint cleaner 100. The base 126 has a diameter greater than the diameters of the housing 102 and the cap 104 to allow the paint cleaner 100 to be free-standing without any legs. The filter 124, shown in more detail in FIG. 12 and FIG. 13, includes a conical-shaped surface 130 with smaller holes 132 arranged around a central opening 134. The combination of smaller holes 132 and central opening 134 provide better control of the runoff out of the paint cleaner. The liquid runoff passes through the filter 124 to the base 126 and out the central opening 128 of the base.

The lid 112, shown in more detail in FIG. 15 and FIG. 16, includes a central opening 140 to receive a portion of the shaft of the spinner 118. The lid 112 includes two openings 142, shown in FIG. 11, to receive fasteners from the knobs 116 to fasten the lid 112 to the top water inlet 114. A central extension 144 of the lid 112 includes a circumferential groove 146 to receive a first o-ring, and a circular groove 148 in the lid 112 receives a second o-ring.

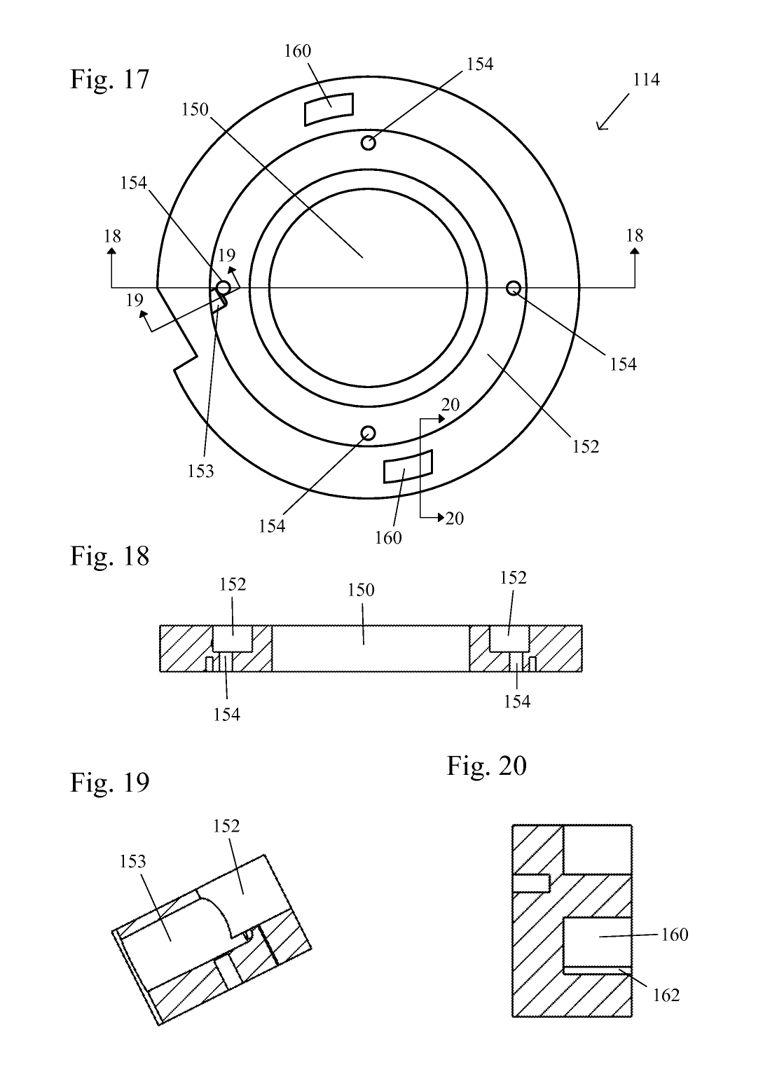

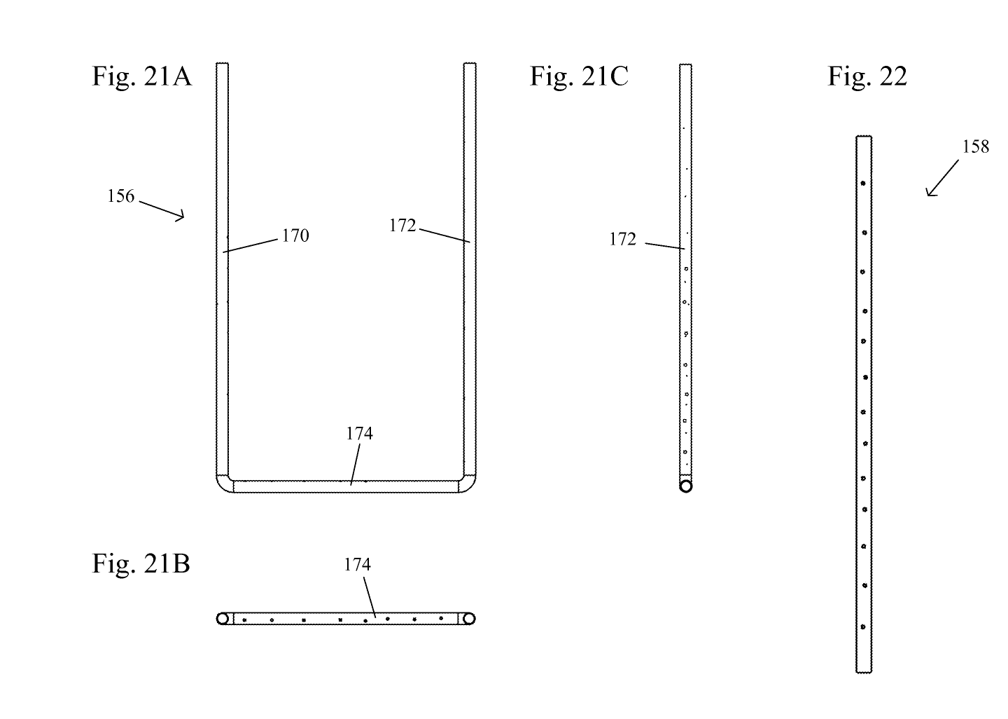

The central extension 144 of the lid 112 inserts into a central opening 150 of the top water inlet 114, shown in more detail in FIG. 17, FIG. 18, FIG. 19, and FIG. 20, and an annular chamber 152 formed between the lid 112 and the top water inlet 114 is sealed by the two o-rings. Water from an external source enters the top water inlet 114 through a port 153, which opens into the annular chamber 152. Four holes 154 through the bottom of the annular chamber 152 lead to the u-shaped nozzle 156 and two straight nozzles 158 with nozzle holes, shown in FIG. 21A, FIG. 21B, FIG. 21C, and FIG. 22. Finally, the top water inlet 114 includes two openings 160 with pocket cutouts 162 to receive and hold the ends of the fasteners of the knobs 116.

As shown in FIG. 21A, the u-shaped nozzle 156 includes a first vertical section 170 and a second vertical section 172, which primarily spray water toward the bristles of a paint brush, and which are connected by two 90-degree elbows to a horizontal section 174 with holes facing upward to spray water primarily toward the tips of the bristles of the paint brush. As shown in FIG. 21C, the vertical sections 170, 172 preferably have larger holes toward the bottom than at the top. The straight nozzles 158 are arranged on opposite sides of the interior space formed by the housing 102 and apply a higher pressure spray than the u-shaped nozzle 156 primarily for cleaning a paint roller cover. As shown in FIG. 22, the holes on the straight nozzles 158 are preferably slightly out of line to provide a better distribution of water spray.

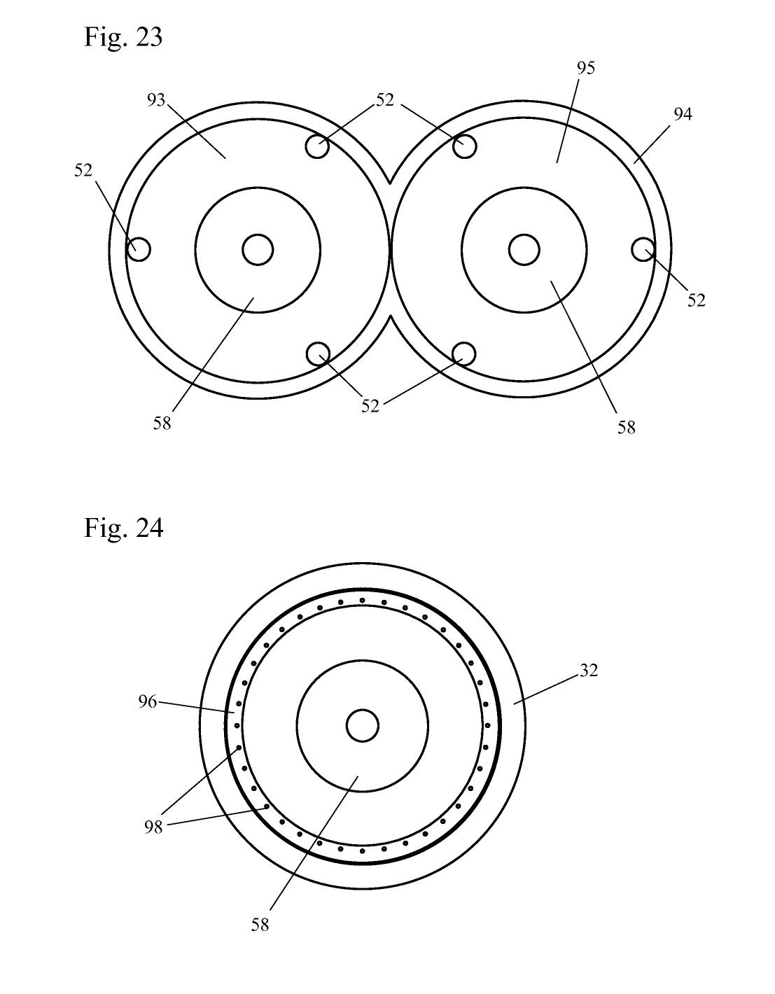

FIG. 23 shows schematically a paint cleaner with a housing 94 to receive and clean two paint roller covers 58, a paint roller cover and a paint brush, or two paint brushes simultaneously. FIG. 23 shows one possible arrangement of tubing 52 to direct water toward the paint roller covers 58. Although the two chambers 93, 95 are shown as separated by a thin wall, the housing 94 may alternatively have a thicker wall or a partial or full opening between the two chambers 93, 95. Although the housing 94 is shown as having curved outer surfaces, the outer surface of the housing 94 may be any shape within the spirit of the present invention.

FIG. 24 shows a bottom view of an alternative nozzle design as part of the water conduit, where the nozzle is in the form of a ring nozzle 96 with the nozzle holes 98 angled downward and inward toward the paint roller cover 58.

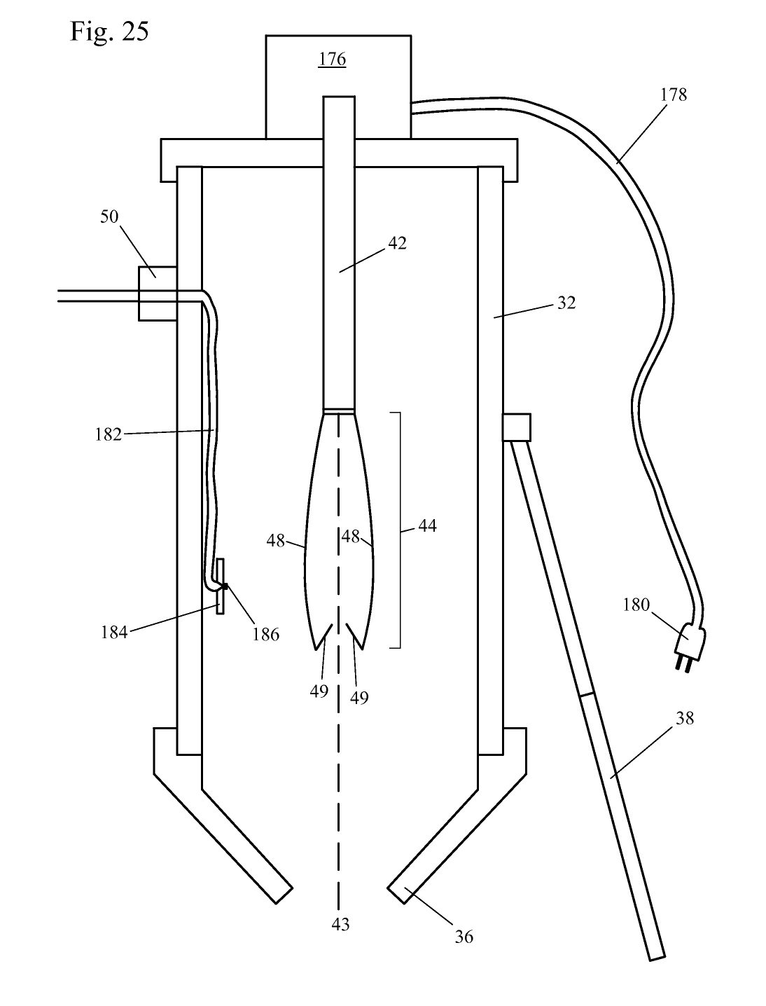

The paint cleaner may alternatively be motorized as shown in FIG. 25. An electric motor 176 with a cord 178 and a plug 180 plugs into an electrical outlet and drives the shaft of the spinner 42 to turn the holder 44. Alternatively, the motor 176 may be battery-powered. The motor 176 is preferably a variable speed motor to allow the user to control the speed of the motor 176.

A motorized nozzle, as shown in FIG. 25 and FIG. 26, may also be used in combination with the electric motor 176. A flexible hose 182 attached to a nozzle plate 184 with a nozzle 186 provides water to the nozzle 186. The nozzle plate 184 is attached to slide up and down on a pair of shafts 188 by gearing located along or in the shafts. An auxiliary motor (not shown) preferably receives electricity from the primary motor 176 by an electrical line through one of the shafts 188 and drives the nozzle plate 184 up and down the shafts 188 to allow the nozzle 186 to spray water along the length of the paint roller cover.

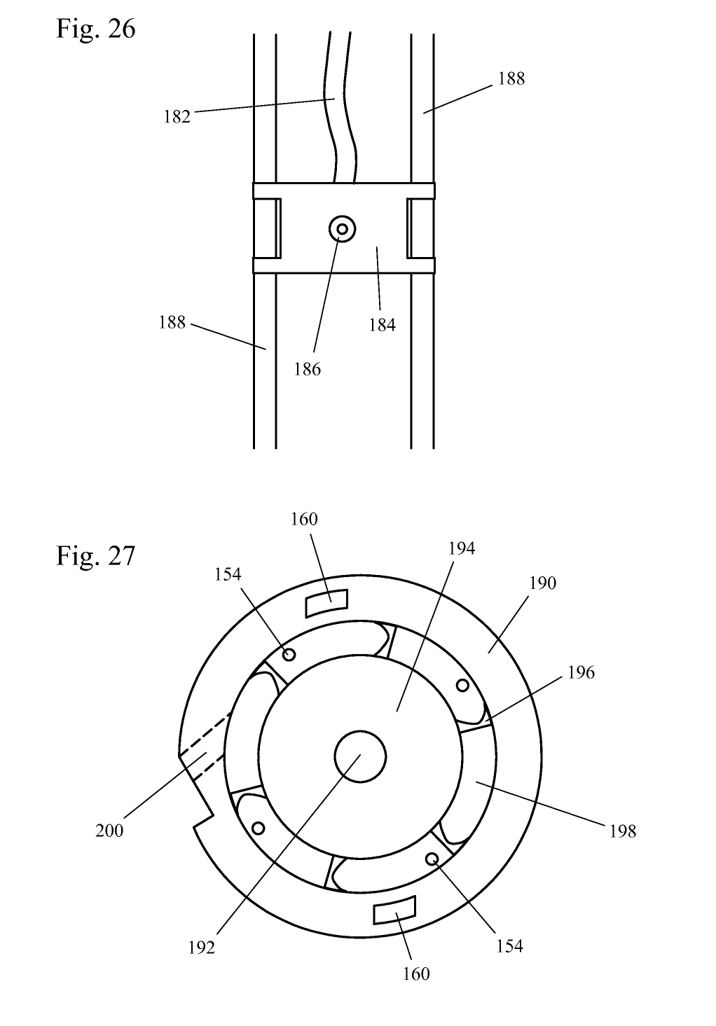

Finally, the force from the water flowing through the water conduit prior to reaching the nozzle may be used to drive the spinner shaft of the paint cleaner as shown in FIG. 27. The top water inlet 190 receives the spinner shaft 192, which has a hub 194 with vanes 196 extending radially outward from the hub 194 across an annular space 198 between the hub 194 and a wall of the top water inlet 190. Water enters the annular space 198 through a conduit 200 through the top water inlet 190 and is directed along a clockwise direction around the annular space 198 for the layout shown in FIG. 27. The water drives the vanes 196, which causes the hub 194 and hence the spinner shaft 192 to rotate in a clockwise direction. As the water travels around the annular space 198, some of it also flows into the holes 154 that lead to the u-shaped nozzle 156 and straight nozzles 158.

### Methods of Operation

A preferred method of cleaning a paint roller cover to remove water-based paint from the cover includes one or more of the following steps.

A 5-in-1 tool is first used to squeeze the majority of the excess paint off the cover.

The paint roller cover is attached to the holder, which extends from the spinner, which is rotatably coupled to the cap body, which is mounted on the top of the housing.

The cap body is then snapped on or screwed on the top of the housing. If a rubber gasket option is used, the rubber gasket is opened in order to slide the paint roller cover in.

In some embodiments, the paint roller cover is cleaned by a series of cycles of soakings from the water conduit and spinnings by the spinner. The valve for the water conduit is preferably turned off and the spinner is actuated. This cycle is repeated until the water exiting the drain runs clear.

In other embodiments, when the water is turned on, the water from the water conduit jets out to contact the paint roller cover in a manner which rotates the paint roller cover on its own. When the drain water runs clear, the water conduit is turned off, and the roller may be spun dry to complete the cleaning.

If a hand drill is used to actuate the spinner, a series of soaks and spins may be used. Alternatively, a long soak with continuous spinning while the water is running may be used.

The cap is then screwed off or snapped off or the rubber gasket is opened to remove the paint roller cover from the housing, and the paint roller cover is then removed from the holder and ready to be reused.

When the paint cleaner is also capable of cleaning a paint brush, the water conduit preferably has a separate on/off valve for a large soft flow of water from lower in the housing to contact the bristles or a harder upward flow from nozzles located below the bristles directed upward toward the bristles.

In some embodiments, the paint brush may be manually cleaned in a sink with the paint cleaner being used only to dry the cleaned paint brush by spinning.

In some embodiments, the spinner includes a screw gun fitting such that the spinner attaches to the gun the same way as a drill bit.

A number of different water entry methods and water conduits may be used for the paint cleaner.

In one embodiment, the water conduit dumps water on the paint roller cover at the upper end for drenching and spinning in series to remove the paint from the paint roller.

In another embodiment, the water conduit extends down the side of the housing inside the housing and includes a plurality of holes to provide streams of water along the length of the paint roller cover or paint brush preferably at an angle to cause the paint roller cover or paint brush to spin.

In another embodiment, the water conduit is spiral in shape with a plurality of holes to provide streams of water directed to cause the paint roller cover or paint brush to spin.

In another embodiment, the water conduit forms a ring or arc around the top of the housing under the lid with a plurality of holes to provide streams of water showering down on the paint roller cover or paint brush. Simultaneous actuation of the spinner distributes the water evenly around the paint roller cover or paint brush. Actuation of the spinner may be continuous or pulsed.

In another embodiment, the water conduit includes two or more pipes extending down and spaced around the enclosure along the housing wall. Each pipe includes a plurality of holes to provide streams of water along the length of the paint roller preferably at an angle to cause the paint roller cover or paint brush to spin.

Any of the described features of the present invention may be used in combination with each other in a paint cleaner within the spirit of the present invention as long as the combination is physically possible.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A paint cleaner comprising:
a housing comprising a housing wall having a first open end and a second open end opposite the first open end;
a drain extending from the first open end of the housing and having a drain opening;
a cap comprising:
a cap body coupled to the second open end of the housing;
a holder to receive a paint roller cover or a brush handle of a paint brush, wherein the paint brush further comprises bristles; and
a spinner coupling the holder to the cap body such that the holder is rotatable with respect to the cap body to rotate the paint roller cover or the paint brush within the housing; and
a water conduit supplying water to an enclosure formed by the housing, the cap, and the drain and directing the water to the paint roller cover or the bristles of the paint brush with the paint roller cover or paint brush being maintained in the enclosure by the holder.

2. The paint cleaner of claim 1 further comprising a plurality of legs extending from an outer side of the housing wall, wherein the legs are retractable.

3. The paint cleaner of claim 1, wherein the spinner comprises a handle extending above the cap body to actuate the spinner by hand.

4. The paint cleaner of claim 1, wherein the spinner comprises at least one fitting reversibly coupleable to a motor-driven tool or a hand crank to actuate the spinner.

5. The paint cleaner of claim 1, wherein the holder comprises a plurality of ribs shaped to receive the paint roller cover and a clamp to receive the brush handle of the paint brush.

6. The paint cleaner of claim 1, wherein the water conduit further comprises an on/off valve controlling entry of water into the enclosure by way of the water conduit.

7. The paint cleaner of claim 1, wherein the water conduit extends through a vertical bore hole in the housing wall to holes or slits in the housing wall connecting the bore hole to the enclosure to supply water to the enclosure.

8. The paint cleaner of claim 1, wherein the water conduit further comprises at least one tubing line extending vertically down along an inner side of the housing wall, the tubing line having a plurality of openings to direct water toward the paint roller cover or the bristles of the paint brush.

9. The paint cleaner of claim 1, wherein the water conduit further comprises a tubing line spiraling along an inner side of the housing wall, the tubing line having a plurality of openings to direct water toward the paint roller cover or the bristles of the paint brush.

10. The paint cleaner of claim 1, wherein the water conduit further comprises a trough with a lip extending around an outer edge of the enclosure in fluid communication with the hole in the housing wall, the trough being positioned to allow water running over the lip to fall on the paint roller cover from above.

11. The paint cleaner of claim 1, wherein the water conduit further comprises a first line positioned to direct water to the paint roller cover, a second line positioned to direct water to the bristles of the paint brush, and at least one valve selectively controlling entry of water into the first line or the second line.

12. The paint cleaner of claim 1, wherein the water conduit further comprises at least one nozzle positioned to direct water upward from below the bristles of the paint brush toward the bristles.

13. The paint cleaner of claim 1, wherein the water conduit further comprises at least one nozzle positioned to direct water to contact the paint roller cover off-axis.

14. The paint cleaner of claim 1, wherein the cap body comprises a lid and a top water inlet forming an annular chamber serving as a portion of the water conduit.

15. The paint cleaner of claim 14, wherein the spinner further comprises a hub extending radially from a shaft of the spinner and a plurality of vanes extending radially from the hub into the annular chamber such that water flowing through the annular chamber drives the vanes to actuate the spinner.

16. The paint cleaner of claim 14, wherein the water conduit further comprises a plurality of nozzles extending from holes through the top water inlet into the enclosure to direct the water from the annular chamber to the paint roller cover or the bristles of the paint brush with the paint roller cover or paint brush being maintained in the enclosure by the holder.

17. The paint cleaner of claim 1, further comprising an electric motor driving a shaft of the spinner to actuate the spinner.

18. The paint cleaner of claim 1, wherein the drain comprises a filter having a plurality of holes to receive runoff from the enclosure and a base seating the filter and having the drain opening to allow the runoff to exit the paint cleaner.

19. A method of cleaning paint off a paint roller cover comprising:
a) placing the paint roller cover on a holder of a paint cleaner, the paint cleaner comprising:
a housing comprising a housing wall having a first open end and a second open end opposite the first open end;
a drain extending from the first open end of the housing and having a drain opening;
a cap comprising:
a cap body coupled to the second open end of the housing;
the holder; and
a spinner coupling the holder to the cap body such that the holder is rotatable with respect to the cap body to rotate the paint roller cover within the housing; and
a water conduit supplying water to an enclosure formed by the housing, the cap, and the drain and directing the water to the paint roller cover being maintained in the enclosure by the holder; and
b) supplying water to the water conduit from a water source until the paint has been cleaned from the paint roller.

20. The method of claim 19 further comprising actuating the spinner to spin the paint roller cover during step b).
